(19) United States
(12) Patent Application Publication
(10) Pub. No.: US 2026/0091433 A1
(43) Pub. Date: Apr. 2, 2026

(54) HEAD OF HEAD-REPLACEABLE CUTTING TOOL, AND CUTTING TOOL

(71) Applicant: TUNGALOY CORPORATION, Fukushima (JP)

(72) Inventors: Yuma KONDOU, Iwaki-shi (JP); Jun OTSUKA, Iwaki-shi (JP)

(73) Assignee: TUNGALOY CORPORATION, Fukushima (JP)

(21) Appl. No.: 19/345,765

(22) Filed: Sep. 30, 2025

(30) Foreign Application Priority Data
Oct. 1, 2024 (JP) 2024-172414

(51) Int. Cl. B23B 29/12

(52) U.S. Cl. CPC B23B 29/12; B23B 2231/24

(57) ABSTRACT

To provide a head capable of preventing complications of work procedures and increase in work hours to improve productivity by configuring a head-replaceable cutting tool for machining a workpiece. A cutting tool is a head-replaceable cutting tool having a shank and machining a workpiece, wherein a head comprises a mounting portion mounted to the shank, and a mounting hole to which a substantially rod-shaped cutting member is mounted. A central axis of the mounting hole is orthogonal to a fastening direction in which the head is fastened to the shank.

### BACKGROUND

### Field

The present disclosure relates to a head of a head-replaceable cutting tool, and a cutting tool having the head.

### Description of Related Art

As a cutting tool capable of bore machining such as drilling, grooving, and lathe-turning while rotating a workpiece (machining object) on an automatic lathe, Patent Publication KR-A-10-2014-0011797, for example, describes a cutting tool assembly with a configuration in which a substantially (roughly) rod-shaped cutting member is held on the leading end side of a bite. The bite of such cutting tool assembly includes a substantially rectangular prism-shaped holder body part, which is a mounting portion to be mounted onto an appropriate tool rest, and a holder leading end part that is provided in such a manner as to extend toward the leading end side of the holder body part and has the cutting member fastened. The holder leading end part is provided with a mounting hole that is connected to a slot (open groove) where a screw hole is drilled. The cutting member is screwed and fastened to the holder leading end part while being inserted into the mounting hole.

### SUMMARY

FIG. 8 is a side view schematically showing a state in which the conventional cutting tool assembly described above is installed on the tool rest. As shown in the diagram, in the conventional cutting tool assembly, the holder leading end part to which the substantially rod-shaped cutting member 610 is fastened is formed integrally with the holder body part, to configure the bite 600. In addition, a main spindle 500 or a wall for holding a workpiece is normally arranged in a direction in which the cutting member 610 is pulled out (the arrow shown in the diagram). Therefore, the cutting member 610 cannot be replaced inside of the automatic lathe, and the entire bite 600 has to be removed from a tool rest 200 in order to replace the cutting member 610. This tends to result in complicated work procedures and increased work hours for replacing the cutting member 610. Thus, a configuration of a so-called head-replaceable tool is conceivable in which the holder leading end part can be removed from the holder body part. However, since the conventional cutting tool assembly described above has an enlarged structure in which the holder leading end part is formed into an L-shape in order to hold the cutting member 610, it is difficult to secure space for further providing a new mechanism or structure for replacing the holder leading end part.

Therefore, the present disclosure was contrived in view of the above circumstances, and an object thereof is to provide a head capable of preventing complications of work procedures and increase in work hours to improve productivity by configuring a head-replaceable cutting tool for machining a workpiece, and a cutting tool having the head.

(1) An example of the head according to the present disclosure is a head of a head-replaceable cutting tool. The head-replaceable cutting tool has a shank and machines a workpiece. The head comprises a mounting portion to be mounted to the shank, and a mounting hole to which a substantially rod-shaped cutting member is mounted (received). Further, a central axis of the mounting hole is configured to be orthogonal to a fastening direction in which the head is fastened to the shank. In this case, by the configuration of the mounting hole described above, the structure of the head can be made simpler and smaller than that of the prior art. Accordingly, a head-replaceable cutting tool that is useful for bore machining of a workpiece by means of the substantially rod-shaped cutting member can be realized. Moreover, since the structure of the head is simplified and downsized as described above, it is possible to reduce interference between the head and the workpiece and interference between the head and cutting tools that could occur when the head-replaceable cutting tool is used next to another cutting tool.

(2) In addition, the configuration described above may comprise a fastening screw hole which is formed (drilled) from a side of the mounting hole so as to communicate with the mounting hole, the fastening screw hole being configured to thereby receive a screw for fixing (fastening) the cutting member to the head. In this manner, the screw for fastening the cutting member can be accommodated inside of the head, contributing to downsizing of the head. Further, since the screw can be easily checked from a side of the head, the cutting member can easily be mounted to the head.

(3) In this case, more specifically, an internal angle α between a central axis of the fastening screw hole and a plane orthogonal to the fastening direction in which the shank and the head are fastened may satisfy the relationship expressed by 0°<α≤90° (expression (1)). By setting the internal angle α within this range, the effective length of the screw for fastening the cutting member to the head can be ensured and at the same time the screw fastening work can be facilitated.

(4) The configuration described above may further comprise a passage (hole, groove, etc.) which is provided in the vicinity of the mounting hole and through which a cutting oil is discharged (released) toward the cutting member mounted to the mounting hole. In this case, since locations for installing a plurality of cutting oil passages can be secured near the cutting member, the amount of cutting oil supplied can be readily increased.

(5) In this case, more specifically, the passage may be configured to be formed as a notch in an opening edge (open rim) of the mounting hole. Accordingly, a plurality of cutting oil passages can be formed easily in positions closer to the cutting member.

(6) Furthermore, a portion other than the mounting portion of the head may has a substantially rectangular prism shape. Accordingly, the entire head can be configured into a shape with an aspect ratio, the head can easily be thinned so that when the head is fastened to the shank and then installed on the tool rest, interference between the head and an adjacent cutting tool can be avoided.

(7) In addition, a configuration is possible in which when the head with the cutting member mounted thereon is fastened to the shank, a cutting edge of the cutting member is positioned on the head side relative to an end surface of the shank. Accordingly, in configuring the cutting member, the entire shape thereof can be simplified and downsized.

(8) The central axis of the mounting hole may be configured to be positioned (arranged) within a short-side width of the shank. Accordingly, the structure of the head can be further simplified and downsized, further reducing interference between the head and the workpiece and interference between the head and cutting tools that could occur when the head-replaceable cutting tool is used next to another cutting tool.

(9) An example of the cutting tool according to the present disclosure can be effectively configured by having the head according to the present disclosure. That is, an example of the present cutting tool is a head-replaceable cutting tool having a shank and machining a workpiece, wherein the head comprises a mounting portion mounted to the shank, and a mounting hole to which a substantially rod-shaped cutting member is received (mounted). The central axis of the mounting hole is orthogonal to the fastening direction in which the head is fastened to the shank.

### BRIEF DESCRIPTION OF DRAWINGS

FIG. 1 is a perspective view showing an example of a state in which a cutting tool according to an embodiment of the present disclosure is mounted to a tool rest of an automatic lathe;

FIG. 2 is a perspective view schematically showing an example of a shank provided in the cutting tool according to an embodiment of the present disclosure;

FIG. 3A is a bottom view showing an example of the head provided in the cutting tool according to the embodiment of the present disclosure;

FIG. 3B is a right side view of the same;

FIG. 4 is a cross-sectional view in which the head is viewed from the front along line IV-IV of FIG. 3B;

FIGS. 5A to 5C are each a bottom view (perspective view) showing an example of a head with a second mounting hole provided so as to have α=0°, α=30°, and α=45°;

FIG. 6A is a bottom view showing an example of the head similarly to FIGS. 5A to 5C, and FIG. 6B is a perspective view schematically showing a state in which a cutting oil is released from the head shown in FIG. 6A, with a cutting member mounted to the head;

FIG. 7 is a right side view showing an example of the cutting tool according to the embodiment of the present disclosure; and

FIG. 8 is a side view schematically showing a state in which the conventional cutting tool assembly is installed on the tool rest.

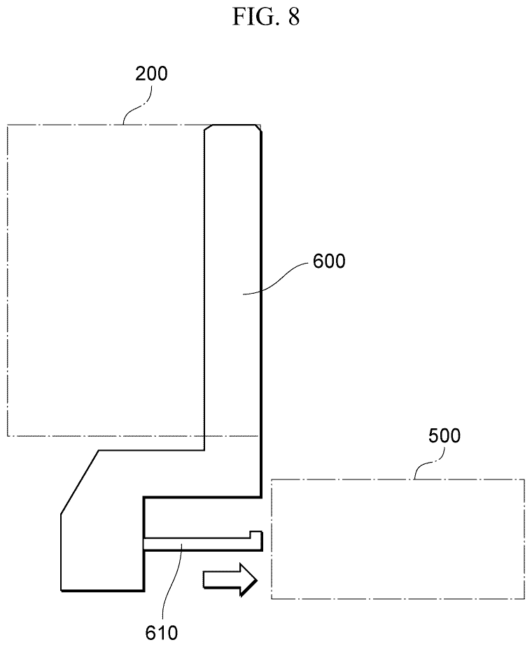

### DETAILED DESCRIPTION

Embodiments will be described hereinafter with reference to the accompanying drawings. In order to facilitate understanding of the description, the same reference signs are given to the same constituent elements in each drawing as much as possible, to omit redundant descriptions. Note that the following embodiments are examples for describing the present disclosure and are not intended to limit the present disclosure to the embodiments. Furthermore, the present disclosure can be modified in various ways so long as the modifications do not depart from the gist of the present disclosure. In addition, those skilled in the art can employ embodiments in which each of the following elements is replaced by an equivalent one, and such embodiments, too, are included in the present disclosure.

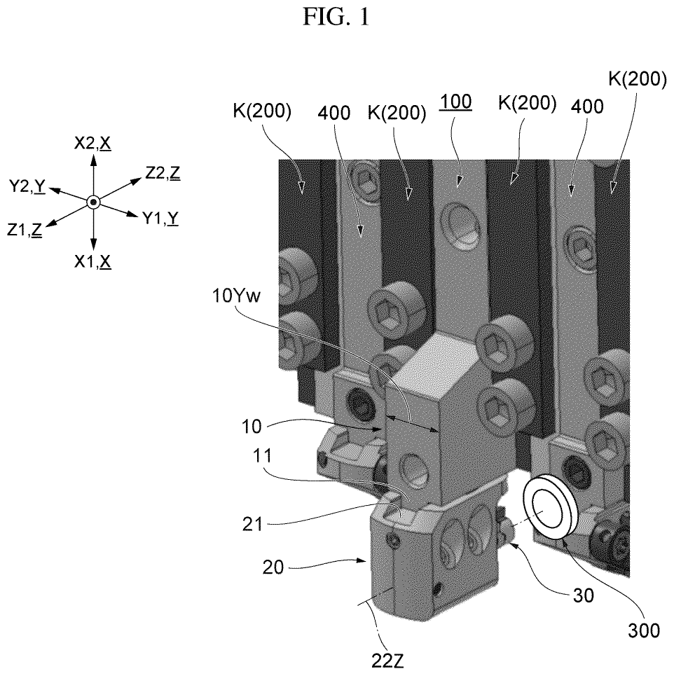

FIG. 1 is a perspective view showing an example of a state in which a cutting tool according to an embodiment of the present disclosure is mounted to a tool rest of an automatic lathe. In order to describe relative directional relationships, for convenience, the downward direction may be referred to as front X1, the upward direction may be referred to as rear X2, and the both directions may be collectively referred to as front-back direction X, in coordinate axes shown in FIG. 1. Also, in the coordinate axes shown in the drawing, the diagonally right downward direction may be referred to as right side Y1, the diagonally left upward direction may be referred to as left side Y2, and the both directions may be collectively referred to as crosswise direction Y. In addition, in the coordinate axes shown in the drawing, the diagonally left downward direction may be referred to as top Z1, the diagonally right upward direction may be referred to as bottom Z2, and the both directions may be collectively referred to as vertical direction Z. In addition, a top view (bottom view) refers to a viewpoint where a head 20 and a cutting tool 100 are viewed facing the bottom Z2 from the top Z1 (facing the top Z1 from the bottom Z2). A front view (back view) refers to a viewpoint where the head 20 and the cutting tool 100 are viewed facing the rear X2 from the front X1 (facing the front X1 from the rear X2). A right side view (left side view) refers to a viewpoint where the head 20 and the cutting tool 100 are viewed facing the left side Y2 from the right side Y1 (facing the right side Y1 from the left side Y2).

As shown in FIG. 1, the cutting tool 100 according to an embodiment of the present disclosure and another cutting tool 400 are applied to automatic lathes (not shown) that perform automatic lathe work, wherein expected bore machining can be performed by fastening a bite to a tool rest 200 having a plurality of comb-edge-like seats K, moving the tool rest 200 in the front-back direction X, crosswise direction Y, and vertical direction Z in accordance with the mode of the lathe-turning work of a workpiece 300 (e.g., the tool rest 200 is normally moved within the XZ plane, and optionally moves in a Y-axis direction as well), and appropriately selecting and switching the cutting tools 100, 400. In some cases, the automatic lathe performs machining where the workpiece 300 is lathe-turned and carved into a three-dimensional shape by moving the cutting tool 100 along an appropriate machining direction while feeding the workpiece 300 in a predetermined direction.

Further, the cutting tool 100 of the present embodiment used in such lathe-turning work is a head-replaceable cutting tool in which the head 20 can be attached/detached to/from a shank 10 of the bite. As shown in FIG. 1, a projection part 11 is provided in a front part of the shank 10, and a recessed part 21 is formed on an upper surface of the head 20. By fitting the projection part 11 and the recessed part 21, the shank 10 and the head 20 can be positioned. As will be described hereinafter, a projection part 25 of the head 20 is mounted to a mounting hole 12 of the shank 10, thereby fastening both.

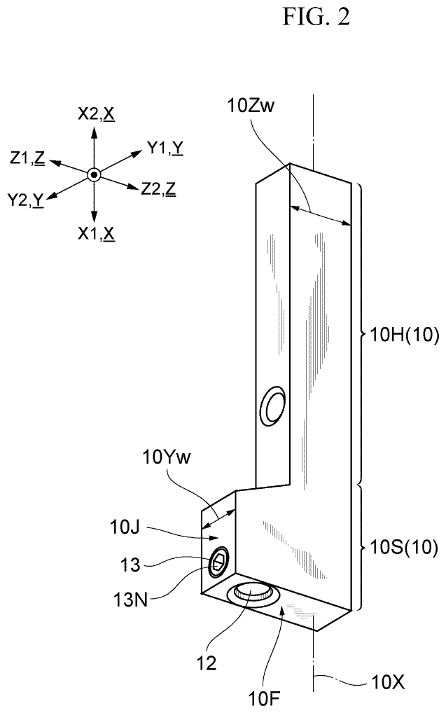

FIG. 2 is a perspective view schematically showing an example of the shank 10 provided in the cutting tool 100. In the shank 10 shown in FIG. 2, the illustration of the projection part 11 shown in FIG. 1 is omitted. As shown in FIG. 2, the shank 10 is obtained by integrally forming a body part 10H arranged on the rear X2 side and a step part 10S arranged on the front X1 side. Of these, the body part 10H is a portion that is installed so as to be held between seats K, K of the tool rest 200 (a portion where a vertical direction width 10Zw is constant). Also, the step part 10S is a portion provided in a step-like manner (i.e., angled, hook-shape, or L-shape) so as to be bent from a lower part of the body part 10H to the top Z1.

A front surface 10F of the step part 10S is provided with the projection part 11, the illustration of which is omitted as described above, and the mounting hole part 12 into which the projection part 25 of the head 20 to be described below is inserted. In addition, a fastening screw hole part 13, which is connected to the mounting hole part 12 and into which a screw 13N for fastening the head 20 to the shank 10 is fitted, is drilled in an upper surface 10J of the step part 10S. The head 20 is fastened to the shank 10 as shown in FIG. 1 by the screw 13N being screwed and fastened to the fastening screw hole 13 and pressing the head 20 in contact with the projection part 25.

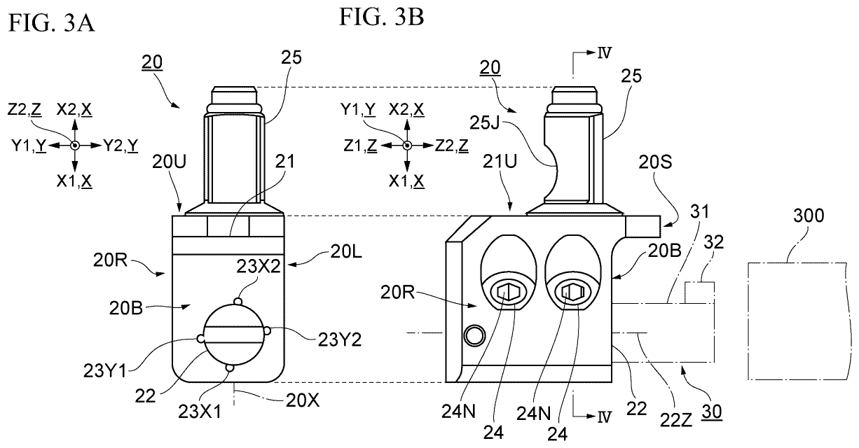

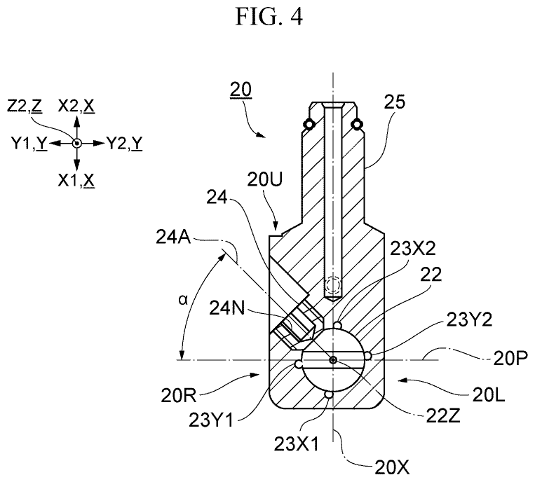

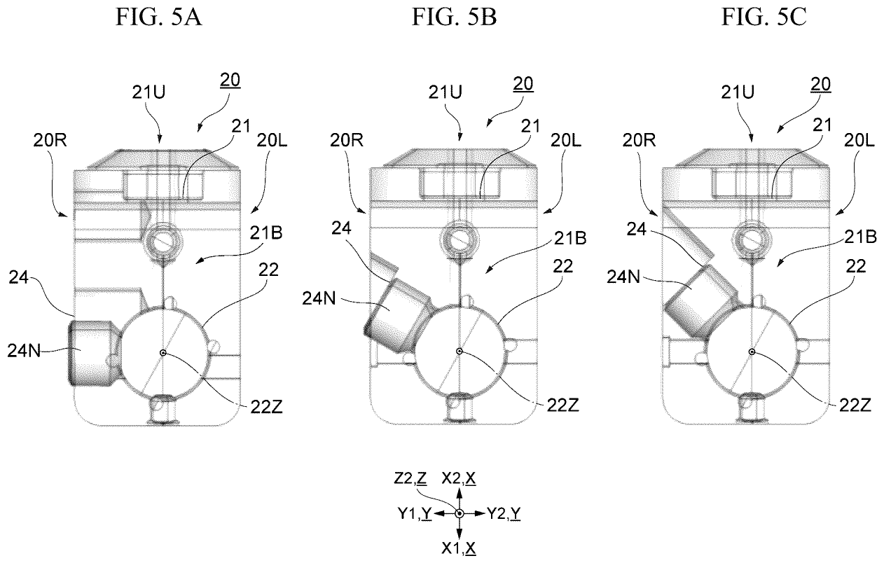

FIG. 3A is a bottom view showing an example of the head 20 provided in the cutting tool 100, and FIG. 3B is a right side view of the same. FIG. 4 is a cross-sectional view in which the head is viewed from the front along line IV-IV of FIG. 3B. As shown in these diagrams, the head has a substantially rectangular prism shape having a downward projection part 20S, and the recessed part 21 that is fitted with the projection part 11 of the shank 10 is provided on the top Z1 side of a back surface 20U of the head 20, as described above. In addition, the projection part 25 (corresponding to an example of “mounting portion” in the present disclosure) that is inserted into the mounting hole 12 of the shank 10 is drilled toward the rear X2, on slightly the bottom Z2 side (lower projection part 20S side) of a back surface 21U. Furthermore, a recessed part 25J, into which the screw 13N fastened into the fastening screw hole 13 of the shank 10 comes into abutment, is formed in an upper surface of the projection part 25. Also, a mounting hole 22 (corresponding to an example of “mounting hole” in the present disclosure) to which a substantially rod-shaped cutting member 30 is mounted is drilled in a bottom surface 21F of the head 20.

A central axis 22Z of this mounting hole 22 is orthogonal to a fastening direction in which the head 20 is fastened to the shank 10 (a fastening direction as viewed relative to the head 20 in which the shank 10 and the head 20 are fastened, which is a direction in which a central axis 20X of the projection part 25 extends (front-back direction X)). Note that, in the present embodiment, this “fastening direction” matches a longitudinal direction in which the shank 10 extends as viewed relative to the shank 10, and matches a direction in which the head 20 moves toward the workpiece 300, as shown in FIG. 3B. In other words, the mounting hole 22 is configured in such a manner that the central axis 22Z thereof is orthogonal to the longitudinal direction (front-back direction X) in which the central axis 20X of the projection part 25 in the head 20 extends and arranged within a short-side width 10Yw of the shank 10 (see FIG. 1).

In addition, a plurality of fastening screw holes 24, 24 (corresponding to an example of “fastening screw hole” in the present disclosure), which are connected to the mounting hole 22 and into which screws 24N for fastening the cutting member 30 to the head 20 are fitted, are drilled in a right side surface 20R of the head 20. By the screws 24N being screwed and fastened to the respective fastening screw hole 24 and pressing the head 20 in contact with a cutting member shank part 31 of the cutting member 30, the cutting member 30 is fastened to the head 20 as shown in FIG. 1 and FIG. 3B. Also, the fastening screw holes 24, 24 are configured in such a manner that the internal angle α between a central axis 24A thereof and a plane 20P (vertical direction Z or crosswise direction Y) orthogonal to the above-described fastening direction in which the head 20 is fastened to the shank 10, that is, the direction in which the central axis 20X of the projection part 25 in the head 20 extends (front-back direction X), preferably satisfies the relationship expressed by the following expression (1), even more preferably the following expression (2), still more preferably the following expression (3).

0°<α≤90° (1)

0°<α≤60° (2)

30°≤α≤60° (3)

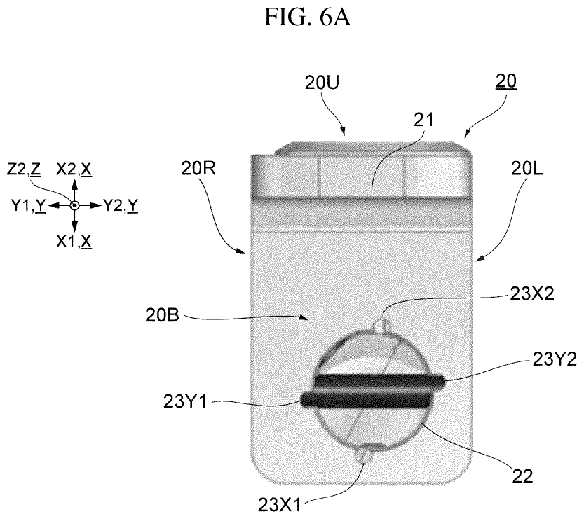

FIGS. 5A to 5C are each a bottom view (perspective view) showing an example of the head 20 with the fastening screw hole 24 provided so as to have α=0°, α=30°, and α=45°. Note that this diagram omits the illustration of the projection part 25.

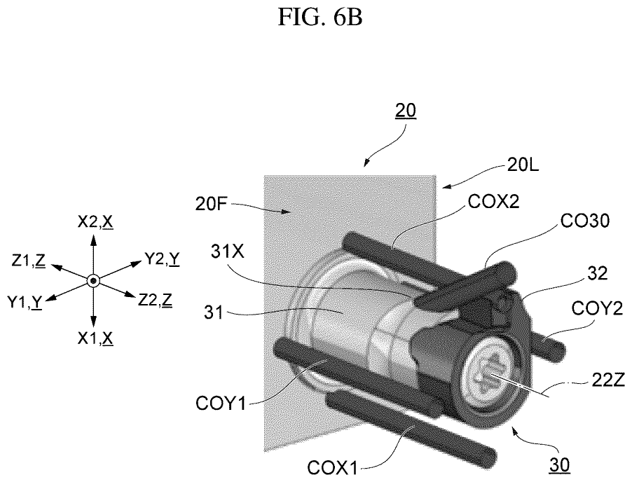

Also, FIG. 6A is a bottom view showing an example of the head 20 similarly to FIGS. 5A to 5C, and FIG. 6B is a perspective view schematically showing a state in which a cutting oil is released from the head 20 shown in FIG. 6A, with the cutting member 30 mounted to the head. As shown in these diagrams as well as FIGS. 3A-3B and 4, an oil hole group 23 for releasing a cutting oil CO (see FIG. 6B) toward the cutting member 30 mounted on the mounting hole 22 is drilled in the vicinity of the mounting hole 22 of the head 20. This oil hole group 23 corresponds to an outlet or supply port of a supply passage (not shown) for the cutting oil CO, which is provided in the shank 10 and the head 20. The cutting oil CO supplied through the head 20 is distributed to each oil hole (corresponding to an example of “passage” in the present disclosure) of the oil hole group 23 and released toward a cutting edge 32 of the cutting member 30 and surroundings thereof.

More specifically, each oil hole of the oil hole group 23 has an opening notched outward from an opening rim of the mounting hole 22, into the shape of an arc having a small curvature. Out of these oil holes, oil holes 23X1, 23X2 through which cutting oils COX1, COX2 (see FIG. 6B) are released are arranged at the front X1 and the rear X2 of the opening of the mounting hole 22, respectively, so as to face each other. Further, oil holes 23Y1, 23Y2 through which cutting oils COY1, COY2 (see FIG. 6B) are released are arranged on the right side Y1 and the left side Y2 of the opening of the mounting hole 22, respectively, so as to face each other. Note that a cutting oil CO30 shown in FIG. 6B is released from an oil hole 31X that is drilled in such a manner as to open from the inside of the cutting member shank part 31 of the cutting member 30 obliquely toward the front X1 of an outer wall.

According to the head 20 configured as described above and the cutting tool 100 having this head, the central axis 22Z of the mounting hole 22 of the head 20 extends in the vertical direction Z in the head 20. That is, the central axis 22Z is orthogonal to the front-back direction X, which is the fastening direction where the head 20 is fastened to the shank 10, and extends in the direction where the head 20 moves toward the workpiece 300. Moreover, the central axis 22Z is configured to be arranged within the short-side width 10Yw of the shank 10. Thus, the structure of the head 20 can be made simpler and smaller (made more compact) than the conventional one, and as a result, in bore machining and the like of the workpiece 300 by the substantially rod-shaped cutting member 30, the cutting tool 100 can be configured as a head-replaceable cutting tool as described in the present embodiment. Accordingly, when replacing the cutting member 30 depending on the shape or cutting mode of the workpiece 300 or when changing the mounting position, replacement can be performed inside of the automatic lathe, which can prevent complications of work procedures and increase in work hours and thereby improve productivity.

Further, since the structure of the head 20 can be simplified and downsized as described above, it is possible to reduce interference between the head 20 and the cutting tool 100 or the workpiece 300 and interference between the head and the other cutting tool 400 that could occur when the cutting tool 100 is used next thereto. Accordingly, many cutting tools 100, 400 can be placed on the tool rest 200 to machine the workpiece 300, thereby reducing the time it takes to replace the cutting tools and further enhancing productivity.

In addition, due to the configuration in which the right side surface 20R of the head 20 is provided with the fastening screw hole 24 connected to the mounting hole 22 and the screws 24N for fastening the cutting member 30 to the head 20 are fitted in the fastening screw hole 24, the screws 24N can be accommodated inside of the head 20. This brings benefits that downsizing of the head 20 is not prevented, that the screws 24N can easily be checked from a side of the head 20, and that the cutting member 30 can easily be mounted to the head 20.

Furthermore, the internal angle α between the central axis 24A of the mounting hole 24 and the plane 20P (front-back direction X or crosswise direction Y) orthogonal to the fastening direction (vertical direction X) where the shank 10 and the head 20 are fastened is configured to satisfy the relationship expressed by, preferably, the following expression (1), more preferably the following expression (2), or even more preferably the following expression (3).

0°≤α≤60° (1)

0°≤α≤45° (2)

30°≤α≤45° (3)

This brings a benefit that the work of fastening the screws 24N for fastening the cutting member 30 to the head 20 can be performed more easily while checking the effectively lengths of the screws 24N.

Additionally, the plurality of oil holes 23X1, 23X2, 23Y1, 23Y2 through which the cutting oils COX1, COX2, COY1, COY2 are released toward the cutting member 30 are arranged as small arc-shaped notches in the vicinity of the mounting hole 22 or, more specifically, the opening rim of the mounting hole 22. Thus, the cutting oil CO can be supplied in large amount from a position near the cutting member 30 toward the cutting member 30, enhancing the cooling performance of the cutting member 30 and further improving productivity and durability.

The present embodiment has been described above. However, the present embodiment is intended to facilitate understanding of the present disclosure and is not intended to interpret the present disclosure in a limited manner. Specifically, the present disclosure is not necessarily limited to the specific configurations described above, and those specific configurations with appropriate design changes by those skilled in the art are also included in the scope of the present disclosure as long as they have the features of the present disclosure. Further, each element, arrangement, material, condition, shape, size, scale, and the like provided by the specific configurations described above are not limited to those shown in the examples, unless otherwise specified, and can be changed as necessary. Moreover, each of the elements provided by the specific configurations described above can be used in any combination as appropriate, as long as there is no technical contradiction.

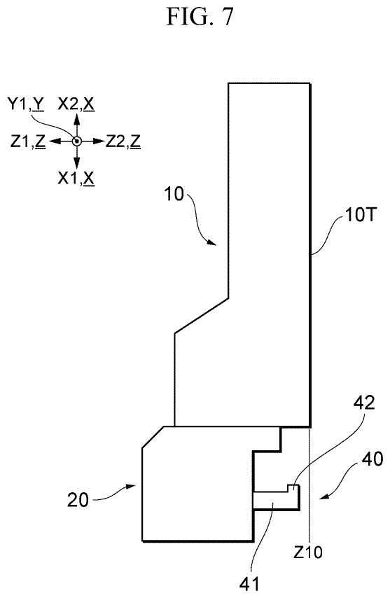

In other words, for example, the mounting hole 24 may be a single component, or three or more of the mounting holes 24 may be provided. Also, the head 20 does not have to be provided with front projection part 20S projecting forward. Further, the screws 13N and screws 24N may not have to be of fitted type. In addition, the mounting hole 24 may be provided on the left side surface 20L instead of or in addition to the right side surface 20R of the head 20. Also, the head 20 may be fastened to the shank 10 by simply mounting projection part 25 to the mounting hole 12 without providing the projection part 11 of the shank 10 and the recessed part 21 of the head 20. Also, when providing the oil hole group 23 in the head 20 alone, for example, the oil hole group 23 may be grooves instead of holes. Furthermore, as shown in FIG. 7, when the head 20 to which a cutting member 40 having a cutting member shank part 41 and a cutting edge 42 is mounted is fastened to the shank 10, it is preferred that the cutting edge 42 be disposed closer to the head 20 side than to a vertical direction position Z10 of an end surface 10T (bottom surface or lower surface) of the shank so that the head can be made even more compact.

According to the present disclosure, since the head-replaceable cutting tool for machining a workpiece can be configured effectively, complications of work procedures and increase in work hours can be prevented, improving productivity.

What is claimed is:

1. A head of a head-replaceable cutting tool that is configured to have a shank and to machine a workpiece, the head comprising:
a mounting portion configured to be mounted to the shank; and
a mounting hole configured to receive a substantially rod-shaped cutting member,
wherein a central axis of the mounting hole is orthogonal to a fastening direction in which the head is fastened to the shank.

2. The head according to claim 1, further comprising a fastening screw hole formed from a side of the mounting hole so as to communicate with the mounting hole, the fastening screw hole being configured to thereby receive a screw for fixing the cutting member to the head.

3. The head according to claim 2, wherein an internal angle α between a central axis of the fastening screw hole and a plane orthogonal to the fastening direction in which the shank and the head are fastened satisfies a relationship expressed by the following expression (1)
0°<α≤90° (1).

4. The head according to claim 1, further comprising a passage provided in the vicinity of the mounting hole and configured to discharge a cutting oil toward the cutting member mounted to the mounting hole.

5. The head according to claim 4, wherein the passage is formed as a notch in an opening edge of the mounting hole.

6. The head according to claim 1, wherein a portion other than the mounting portion has a substantially rectangular prism shape.

7. The head according to claim 1, wherein when the head with the cutting member mounted thereon is fastened to the shank, a cutting edge of the cutting member is positioned on the head side relative to an end surface of the shank.

8. The head according to claim 1, wherein the central axis of the mounting hole is positioned within a short-side width of the shank.

9. A cutting tool comprising the head according to claim 1.
